(19) United States
(12) Patent Application Publication
(10) Pub. No.: US 2006/0146416 A1
(43) Pub. Date: Jul. 6, 2006

(54) Zoom lens focus adjustment apparatus using lens of variable refractive power

(75) Inventor: Chang Hawan Lee, Seoul (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/319,462

(22) Filed: Dec. 29, 2005

(30) Foreign Application Priority Data
Dec. 31, 2004 (KR) 10-2004-0118403

(51) Int. Cl. G02B 15/14

(52) U.S. Cl. 359/676

(57) ABSTRACT

A zoom lens focus adjustment apparatus is provided. The apparatus includes a focusing part, a variator, and a compensator. The focusing part is disposed in a front side and focuses on an object. The variator changes a zoom ratio using a lens of a variable refractive power that changes the refractive index of the lens using a voltage applied from the outside, thereby performing a zooming operation of a zoom lens. The compensator compensates for the position of an image plane using the change of the zoom ratio by the variator.

### BACKGROUND OF THE INVENTION

1. Field of the Invention

The present invention relates to a camera for taking a picture, and more particularly, a zoom lens focus adjustment apparatus using a lens of a variable refractive power to miniaturize a zoom lens.

2. Description of the Related Art

The related art zoom lens requires many lenses ranging from several lenses to tens of lenses.

Also, the zoom lens requires an external power source for controlling the movement of a lens group so as to perform a zooming operation that changes and compensates for the refractive power of each lens group.

The power source includes a stepping motor, an electromagnetic motor, and a piezo motor.

Recently, a zoom camera, which has been used for the related art digital still camera (DSC), is mounted in mobile products such as camera phones, personal digital assistants (PDAs), and notebook computers. Therefore, miniaturization of a zoom camera module is required.

As a molding technology develops recently, an aspherical lens can be manufactured, which reduces the number of lenses required for a zoom lens.

FIG. 1 is a view illustrating the construction of a zoom lens focus adjustment apparatus according to the related art.

Referring to FIG. 1, the zoom lens includes a focusing part 10 for exactly focusing on an object, a variator 20 for changing magnification of an image, a compensator 30 for compensating for an image plane according to zooming, and an image forming part (not shown) forming an image on the image plane. The focusing part 10, the variator 20, and the compensator 30 includes at least one lens 11, 21, and 31, respectively. A relay part may be disposed after the compensator 30.

Since such a zoom lens is designed with consideration of a rigid lens, design of a lens group is made first to satisfy magnification and to minimize aberration caused by a field curvature and chromatic aberration by appropriately selecting a material and distributing a refractive power. Next, design of each lens group is made in detail considering the number of lenses and the shape of the lenses contained in each lens group.

Since a lens contained in the focusing part 10 is a fixed type lens, the variator 20 disposed in the intermediate portion of the apparatus adjusts magnification by moving a lens 21 back and forth along an optical axis using a transfer member 24 and a first motor 23 according to a distance up to an object to change a zoom ratio. The compensator 30 moves the position of a lens 31 through the movement of an optical axis of a lens group using a second motor 33 to compensate for position change of an image plane caused by the changing of the zoom ratio, thereby maintaining a fixed image plane.

Therefore, the related art apparatus requires motors as driving means 23 that moves the variator 20 and the compensator 30. The motors include stepping motors, electromagnetic motors, and piezo motors. However, the motors have a problem that all of the motors are mechanically large and thus it is difficult to apply the motors to portable apparatuses.

### SUMMARY OF THE INVENTION

Accordingly, the present invention is directed to a zoom lens focus adjustment apparatus that substantially obviates one or more problems due to limitations and disadvantages of the related art.

An object of the present invention is to provide a zoom lens focus adjustment apparatus capable of performing a zooming operation through curvature change by applying a variable curvature lens to a variator.

Another object of the present invention is to provide a zoom lens focus adjustment apparatus capable of adjusting a zoom lens focus by applying a liquid crystal lens and/or a lens of a variable refractive power to a variator and/or a compensator.

A further another object of the present invention is to provide a zoom lens focus adjustment apparatus having an advantage of securing a mechanical margin by changing the curvature of a lens without a motor to achieve miniaturization of the apparatus and to minimize interference between lens groups.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a zoom lens focus adjustment apparatus including: a focusing part disposed at a front side to focus on an object; a variator for changing a zoom ratio using a lens of a variable refractive power that changes the refractive index of the lens when a voltage is applied from the outside for zooming of a zoom lens; and a compensator for compensating for the position of an image plane using the change of the zoom ratio by the variator.

In another aspect of the present invention, there is provided a camera module provided to a mobile communication terminal, for taking a photograph, the camera module including: a focusing part disposed at a front side to focus on an object; a variator including at least one lens and changing a zoom ratio when a voltage is applied; and a compensator for compensating for the position of an image plane using the change of the zoom ratio by the variator.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating the construction of a zoom lens focus adjustment apparatus according to the related art;

FIG. 2 is a view illustrating the construction of a zoom lens focus adjustment apparatus using a lens of a variable refractive power according to an embodiment of the present invention;

FIG. 3 is a view illustrating the construction of a zoom lens focus adjustment apparatus using a lens of a variable refractive power according to another embodiment of the present invention;

FIG. 4 is a view illustrating an operation of a lens of a variable refractive power according to the present invention;

FIG. 5 is a view illustrating an operation of a liquid crystal lens according to the present invention;

FIG. 6 is a graph illustrating refractive power of a liquid crystal lens versus voltage applied in the liquid crystal lens of FIG. 5; and

FIG. 7 is a view illustrating refractive index change of a liquid crystal lens according to the present invention.

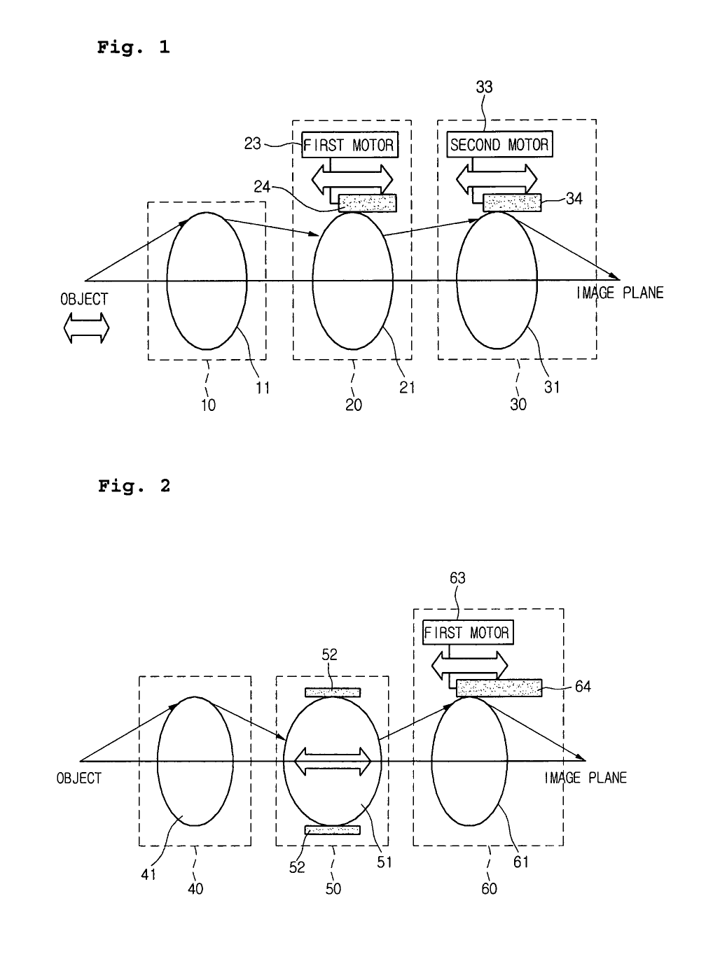

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

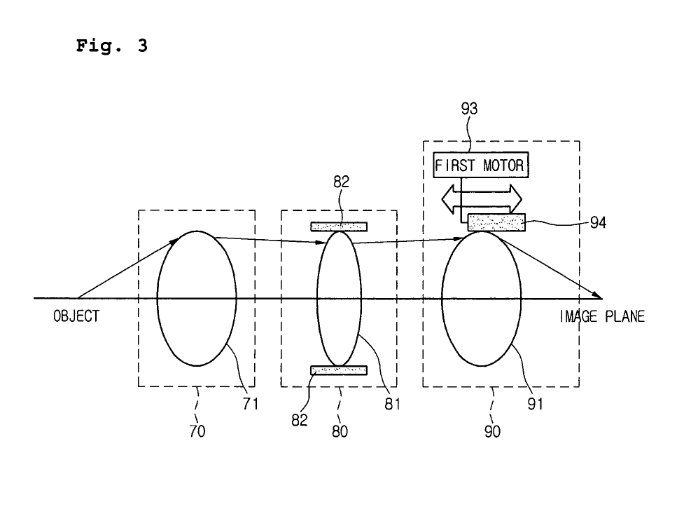

FIG. 2 is a view illustrating the construction of a zoom lens focus adjustment apparatus using a lens of a variable refractive power according to an embodiment of the present invention.

Referring to FIG. 2, the apparatus includes a focusing part 40, a variator 50, and a compensator 60. The variator 50 includes a variable refractive index lens 51 that changes a refractive index thereof using a voltage applied to both ends 52 of the lens 51. The compensator 60 operates a lens 61 to an optical axis direction using a motor 63 to maintain an image plane at a fixed state.

Referring to FIG. 3, the variator 80 includes a liquid crystal lens 81 that changes a refractive index thereof using the arrangement of liquid crystal when a voltage is applied to both ends 82 of the liquid crystal.

The zoom lens focus adjustment apparatus using the lens of the variable refractive power will now be described with reference to the accompanying drawings.

Referring to FIG. 2, the focusing part 40 is installed in a rigid type at a front side to exactly focus a lens of the focusing part with respect to an object, and the variator 50 disposed in the intermediate portion changes a zooming ratio.

At this point, the variator 50 does not move the lens 51 but changes the refractive index of the lens 51 using a voltage applied to both ends 52 of the lens 51. That is, the variator 50 uses the lens 51 of the variable refractive index. The lens 51 of the variable refractive index changes the curvature thereof according to a voltage applied to the lens 51.

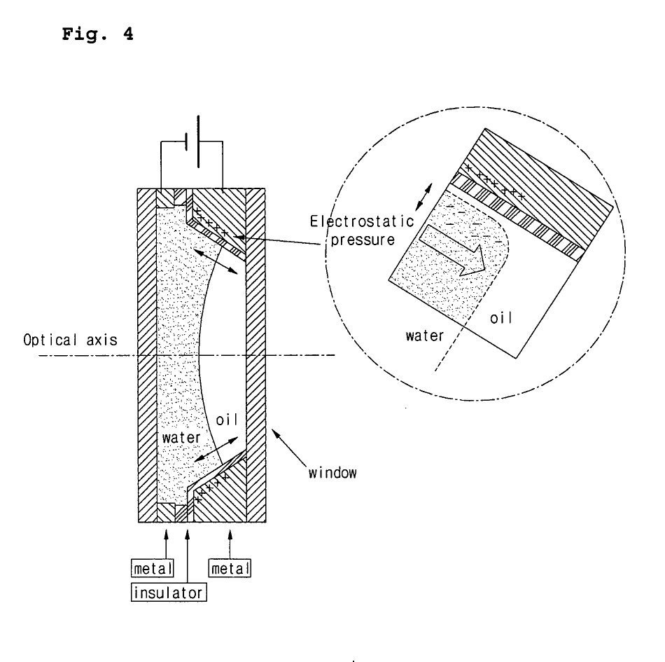

The lens 51 of the variable refractive index includes a varifocal lens illustrated in FIG. 4. The varifocal lens includes different media, e.g., water and oil filling the inside of the lens. When a voltage is applied between metal pads located at both ends of the lens, a boundary portion formed by the water and the oil is moved by electrostatic force generated between the water and the oil. That is, since an electrostatic pressure is generated and the boundary portion between the water and the oil is moved, a refractive index changes on the whole, which changes magnification of an image.

The compensator 60 compensates for the position change of an image plane by moving an optical axis of a group of lenses 61 using a transfer member 64 and a driving means 63, thereby maintaining a fixed image plane. That is, the lenses 61 are moved along the transfer member 64 by driving the group of the lenses 61 using a motor, which is the driving means 63.

For another embodiment, the compensator 60 may be a varifocal lens illustrated in FIG. 4. That is, it is possible to achieve the same compensation effect by controlling the refractive index using a voltage applied to the varifocal lens with respect to the movement to the optical axis direction. Therefore, since the motor and the transfer member are not required, the compensator may be miniaturized.

FIG. 3 is a view illustrating the construction of a zoom lens focus adjustment apparatus using a liquid crystal lens as a lens of a variable refractive power according to another embodiment of the present invention.

Since a focusing part 70 and a compensator 91 are the same as those of FIG. 2, detailed description thereof will be omitted.

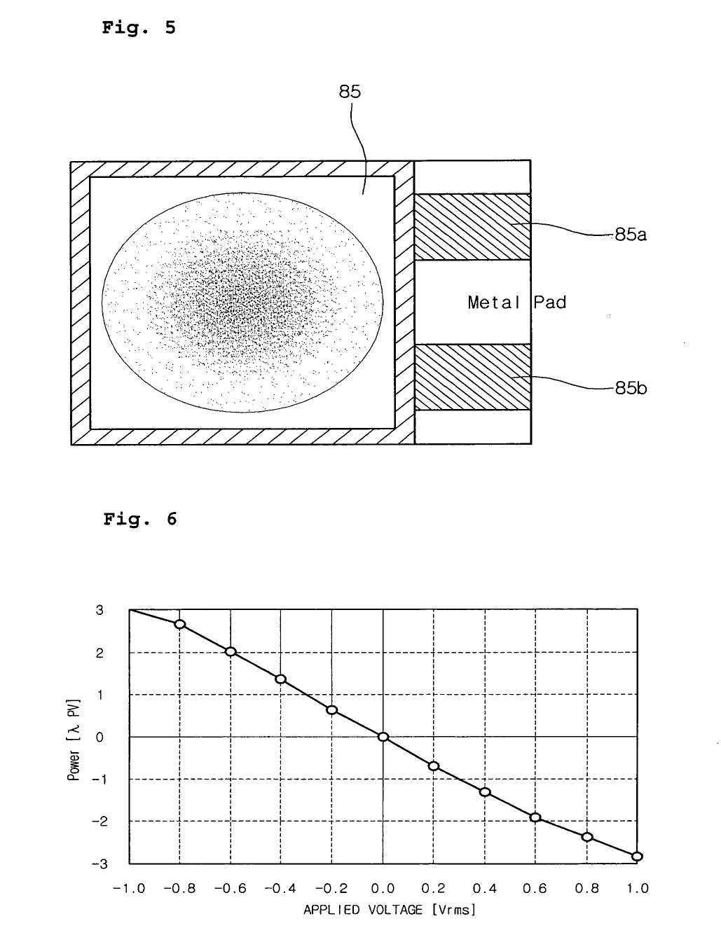

A variator 80 includes a liquid crystal lens 81 illustrated in FIG. 5, which changes the refractive index of a lens contained in the variator 80 according to the arrangement of liquid crystal when a voltage is applied to both ends of the liquid crystal. A voltage is applied to electrodes 85a and 85b located at both ends of the liquid crystal, so that a refractive index of the liquid crystal lens 85 may change, which changes a zoom ratio.

The principle of the liquid crystal lens is that a voltage is applied to both ends of the liquid crystal lens to change the refractive index of the liquid crystal. According to the liquid crystal lens, the refractive power of the liquid crystal lens is changed without changing of the curvature of the liquid crystal lens.

In detail, when an electric field is applied to a liquid crystal layer, liquid crystal molecules contained in the liquid crystal layer are rearranged in the direction of the electric field and the progression direction of light changes due to a difference between a refractive index in a long axis direction and a refractive index in a short axis direction of the liquid crystal molecule while light passes through the liquid crystal layer. The liquid crystal injected for the purpose of the liquid crystal lens may be liquid crystal having a large refractive index anisotropy Δ n so as to properly control an optical path and a phase difference of light that passes through the liquid crystal layer.

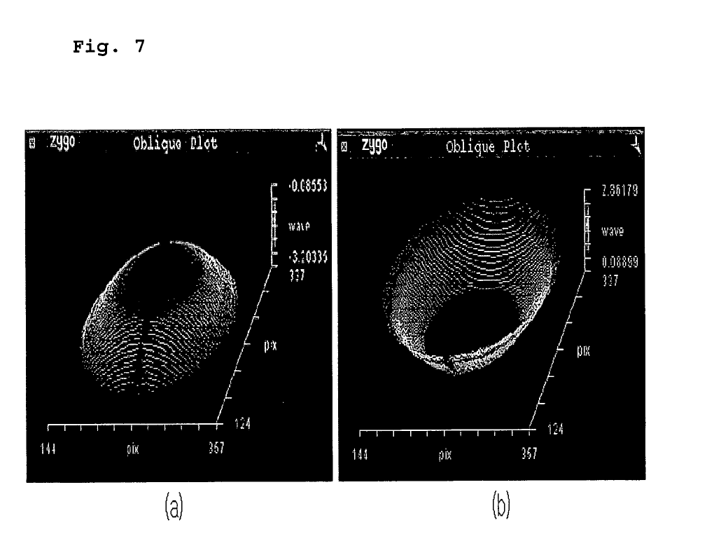

FIG. 6 is a graph illustrating refractive power of a liquid crystal lens versus voltage applied in the liquid crystal lens of FIG. 5. FIG. 7 illustrates a refractive power change of a liquid crystal lens experimentally verified according to the present invention. The liquid crystal lens changes into a concave lens or a convex lens depending on the refractive index of the liquid crystal lens.

According to the present invention, one of the variator and the compensator may be the varifocal lens and the other may be the liquid crystal lens. Also, the varifocal lens or the liquid crystal lens may be applied to both the variator and the compensator. Also, one of the variator and the compensator may have a construction that uses a motor as that of the related art variator or compensator. Therefore, miniaturization of a zoom lens module is achieved.

The present invention provides the zoom lens focus adjustment apparatus appropriate for the characteristics of a mobile communication terminal.

The mobile communication terminal has characteristics of a small size and a slim profile. Particularly, most of mobile communication terminals recently brought to the market include a camera module.

Most of cameras provided to the mobile communication terminals include a lens of high resolution but do not provide a zoom function or do not sufficiently provide the zoom function.

According to the present invention, it is possible to achieve a sufficient zoom function in a small size by applying the zoon lens focus adjustment apparatus to the mobile communication terminal.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A zoom lens focus adjustment apparatus comprising:
a focusing part disposed at a front side to focus on an object;
a variator for changing a zoom ratio using a lens of a variable refractive power that changes the refractive index of the lens when a voltage is applied from the outside for zooming of a zoom lens; and
a compensator for compensating for the position of an image plane using the change of the zoom ratio by the variator.

2. The apparatus according to claim 1, wherein the lens of the variable refractive power comprises a varifocal lens having a curvature that changes when a voltage is applied to both ends of the varifocal lens formed by a boundary between different media in the inside.

3. The apparatus according to claim 1, wherein the lens of the variable refractive power comprises a liquid crystal lens that changes a refractive index thereof according to liquid crystal magnification when a voltage is applied to both ends of the liquid crystal lens.

4. The apparatus according to claim 1, wherein the compensator comprises one of a varifocal lens and a liquid crystal lens.

5. A camera module provided to a mobile communication terminal, for taking a photograph, the camera module comprising:
a focusing part disposed at a front side to focus on an object;
a variator including at least one lens and changing a zoom ratio when a voltage is applied; and
a compensator for compensating for the position of an image plane using the change of the zoom ratio by the variator.

6. The camera module according to claim 5, wherein the variator includes a lens of a variable refractive power that changes the refractive index of the lens so as to perform a zooming operation of a zoom lens.

7. The camera module according to claim 5, wherein the variator includes a varifocal lens having a curvature that changes when a voltage is applied to both ends of the varifocal lens formed by a boundary between different media.

8. The camera module according to claim 5, wherein the variator includes a liquid crystal lens that changes a refractive index thereof according to liquid crystal magnification using a voltage applied to both ends of the liquid crystal lens.

9. The camera module according to claim 5, wherein the compensator comprises a varifocal lens having a curvature that changes when a voltage is applied to both ends of the varifocal lens formed by a boundary between different media.

10. The camera module according to claim 5, wherein the compensator comprises a liquid crystal lens that changes a refractive index thereof according to liquid crystal magnification using a voltage applied to both ends of the liquid crystal lens.
